(19) United States
(12) Patent Application Publication
(10) Pub. No.: US 2004/0266528 A1
(43) Pub. Date: Dec. 30, 2004

(54) Apparatus and a method for more realistic video games on computers or similar devices using visible or invisible light and a light sensing device

(76) Inventor: Xiaoling Wang, Princeton Junction, NJ (US)

Correspondence Address: Mr. Walter J. Teneza Jr., Suite 3, 10 Station 10 Place, Metuchen, NJ, 08840, US

(21) Appl. No.: 10/609,026

(22) Filed: Jun. 27, 2003

(51) Int. Cl. A63F 13/00

(52) U.S. Cl. 463/37

(57) ABSTRACT

An apparatus, system, and a method for providing more realistic input for video games on computers, or similar devices is provided. The apparatus may include a mock shooting device, having a lighting device. The apparatus may also include a screen for displaying visual target objects of a video shooting game, at which a game player can shoot at with the mock shooting device, a light sensing device that detects light from the mock shooting devices, and an input computing device that computes the hit position of the mock shooting device on the screen device based on the signals from the light sensing device. The apparatus may also be used for other interactive video games.

### FIELD OF THE INVENTION

This invention relates to the field of systems and methods for video games, which entail the use of mock input devices, such as a mock gun for shooting games. These video games are typically comprised of computer software which is run on computers, game console machines or similar devices.

### BACKGROUND OF THE INVENTION

Video games, which entail the use of mock shooting devices, are popular and entertaining. These video games are typically comprised of computer software which is run on computing devices, such as home personal computers. However, most computer video games, which entail the use of mock shooting devices typically, use computer peripherals, such as a keyboard, a mouse or a joystick to aim and shoot at visual targets on a computer or video screen. Game console machines, such as the PLAYSTATION (trademarked) from SONY (trademarked) and the XBOX (trademarked) from MICROSOFT (trademarked), use a game pad or other game control device to aim and shoot at visual targets on a computer video screen. These types of peripheral devices make the shooting games somewhat less realistic. In general, most video games can be played much more realistically when a mock control device, such as a mock shooting device for video shooting games, a mock glove for video boxing games, or a mock snowboard for snowboarding games.

There have been some attempts to make video shooting games which entail the use of mock shooting devices, more realistic. Typically, known prior art in the field of shooting video games, as described in the U.S. Pat. Nos. 5,366,229 to Suzuki and 6,146,278 to Kobayashi, incorporated herein by reference, rely on three major components: a mock gun that can emit a light beam to a target on a screen to be shot at, a video camera that photographs the screen for detecting an intersecting point of the light beam on the screen, and a position determination device that determines the actual position of the light beam on the screen. The position of the light beam on the screen can then be fed back to shooting video game control computer software to determine if a visual target on a screen is “hit” or not. Some visual and audio feedback signals indicating hit or miss can be generated. Although these systems are more realistic than the shooting video games with keyboards or joysticks, they are not very suitable for use with the shooting video games on computers or similar devices.

The main reason is the fact that a normal video camera used to photograph a computer monitor screen may not be able to provide steady video images of the computer monitor screen due to the difference in frequencies of the monitor and the video camera. The monitor refresh frequency is typically selectable between sixty-one hundred and twenty Hz while the video camera capturing frequency is typically less than thirty Hz. The video camera capturing frequency is also processing speed and image size dependent. Fast computers may be able to capture thirty video frames per second (thirty Hz) with an image size of 640 by 480 pixels. Slow computers may only be able to capture ten frames per second (ten Hz) with the same image size and thirty frames per second for a smaller size of for example 320 by 240 pixels. Only if both frequencies are identical or the monitor refresh frequency divided by the camera capturing frequency is an integer in a more general term, steady video images of the monitor screen may be captured. Since a computer user may use any refresh frequency from a wide range of monitor refresh frequencies and most video cameras have a typical capturing frequency of between ten and thirty Hz, it is very common that video cameras do not provide steady video images from a computer monitor due to the frequency mismatch.

In addition to the frequency mismatch problem mentioned above, the camera in the prior art as described in the U.S. Pat. No. 5,366,229, incorporated by reference herein, must be placed somewhere near a game player and facing the same orientation as the game player for capturing the display screen. Although this may not present a serious problem in a professionally designed game playing place, it could be very challenging to place the video camera at home in such a way that it may not easily be occluded at anytime during the game and may not easily be bumped into. This is not always practical. In order to solve the difficult camera placement problem, the camera as described in the U.S. Pat. No. 6,146,278, incorporated herein by reference, is integrated with the mock shooting device so that the camera is always facing the target screen without the danger of occlusion. However, this arrangement makes the mock shooting device somewhat expensive and the integrated video camera totally single-purposed. Furthermore, the mock shooting device with the camera must be connected to the computing device directly via a cable, which may also cause inconvenience when playing.

The above mentioned drawbacks, namely, the frequency mismatch between the display screen and the low-cost video camera, the difficult placement of the video camera facing the screen, relatively high cost for a mock shooting device with an integrated camera, as well as a needed connection cable between the mock shooting device and the computing device, all can seriously limit the applicability of the prior art techniques for game players who want to play realistic video shooting games with their computers at home.

There is one successful mock control device on the market now for car racing video games. The car racing mock control device is typically comprised of a mock steering wheel and a mock foot control device with a brake and an accelerator The car racing mock control device is essentially just a normal game control pad but shaped like a wheel. Car racing games in general need only left and right turning control signals, as well as brake and acceleration control signals. They don't need more complex spatial position information that is required by a wide range of other video games, such as shooting, boxing, and most ball related video games.

### SUMMARY OF THE INVENTION

The present invention is intended to provide fast and accurate spatial position information of an object, such as an aiming position of a mock shooting device, or a hit position of a boxing fist, from a mock control device to video games.

The present invention in at least one embodiment provides an apparatus comprising a game computing device, an input computing device, a screen device having a screen, a light sensing device, and a first mock shooting device having a first lighting device. The light sensing device may detect light from the first lighting device. The input computing device may use signals from the light sensing device to determine whether the first mock shooting device is aimed towards a first location on the screen of the screen device. The input computing device typically sends the determination of whether the first mock shooting device is aimed towards the first location to the game computing device.

The light sensing device may surround the screen. The light sensing device may be comprised of a plurality of light sensors. The light sensing device may be comprised of four sensor strips placed around the screen, with each sensor strip comprised of a plurality of light sensors. The first lighting device of the first mock shooting device may project a light pattern onto the light sensing device. The light sensing device may be electrically connected to the input computing device and may provide data about the first lighting device to the input computing device. The light pattern may be a cross light pattern.

The first mock shooting device may be further comprised of a wireless commanding device. The wireless commanding device may send a shooting command when the first mock shooting device is triggered. The first mock shooting device may be further comprised of one or more control buttons. The control buttons may be used to send control command signals. The wireless commanding device may send a unique command signal when one of the control buttons on the first mock shooting device is operated. The wireless command receiving device may be electrically connected to the input computing device and may pass command signals received from the wireless commanding device to the input computing device.

The input computing device may include an integrated wireless command receiving device that computes the aiming position of the first lighting device on the screen and receives command signals from the wireless commanding device of the first mock shooting device. The first mock shooting device may be further comprised of a wired communications line that communicates command signals directly from the first mock shooting device to the input computing device. The light from the first lighting device may be visible or invisible to human eyes but visible to the light sensing device.

The apparatus may further include a second mock shooting device comprised of a second lighting device. The first lighting device of the first mock shooting device may have a first characteristic and the second lighting device of the second mock shooting device may have a second characteristic; wherein the first characteristic and the second characteristic are different. The first characteristic may be comprised of a first light wavelength which is emitted from the first lighting device and the second characteristic may be comprised of a second light wavelength which is emitted from the second. The first characteristic may be comprised of a first light pattern which is emitted from the first lighting device and the second characteristic may be comprised of a second light pattern which is emitted from the second lighting device.

The first mock shooting device may be comprised of a first identifier and the second mock shooting device may be comprised of a second identifier. The first identifier and the second identifier may be different. The first mock shooting device may use the first identifier to send command signals with a first characteristic. The second mock shooting device may use the second identifier to send command signals with a second characteristic; wherein the first characteristic and the second characteristic are different.

The light sensing device may be comprised of a plurality of sets of light sensors. Each set of light sensors may detect light with a certain characteristic. The plurality of sets of light sensors may be placed interlaced around the screen.

The present invention in one or more embodiments also provides a method comprising using a light pattern from a first lighting device fixed to a first mock shooting device to determine whether the first mock shooting device is aimed towards a first location on a screen. The method may include detecting light from the first lighting device through the use of a light sensing device. The method may further include using a wireless or wired commanding device to send command signals from the first mock shooting device.

Light from a second lighting device fixed to a second mock shooting device can also be used to determine whether the second mock shooting device is aimed towards a second location on a screen.

### BRIEF DESCRIPTION OF THE DRAWINGS

FIG. 1 is a perspective view schematically illustrating the overall structure of one embodiment of the present invention;

FIG. 2 is a perspective view schematically illustrating the overall structure of another embodiment of the present invention;

FIG. 3 is a perspective view schematically illustrating the overall structure of another embodiment of the present invention;

FIG. 4 is a perspective view schematically illustrating the cross light pattern generated by a lighting device of a mock shooting device;

FIG. 5A illustrates a screen device with a light sensing device placed around a display screen;

FIG. 5B depicts the screen device of FIG. 5A with the light sensing device placed around the display screen, with a projected cross pattern from the lighting device of FIG. 4 of the mock shooting device of FIG. 4;

FIG. 5C illustrates the situation when a screen device with a light sensing device placed around a display screen only on three sides instead of four, with a projected cross pattern from a lighting device of a mock shooting device;

FIG. 6A illustrates a section of the sensing device shown in FIG. 5A;

FIG. 6B illustrates a typical signal response of the section in FIG. 5A to light projected by a lighting device of a mock shooting device, as well as how the estimated position can be obtained;

FIG. 7A illustrates a section of the a sensing device with two sets of interlaced light sensors for detecting light signals from two different mock shooting devices;

FIG. 7B illustrates a section of the a sensing device with four sets of interlaced light sensors for detecting light signals from four different mock shooting devices;

FIG. 8A depicts a screen device with a light sensing device placed around the display screen, with a first projected light cross patterns from a first distance;

FIG. 8B depicts a screen device with a light sensing device placed around the display screen, with a second projected light cross pattern from a second distance;

FIG. 9A shows a marking device, and FIGS. 9B-9D show the marking device of FIG. 9A located on an object;

FIG. 9E shows a marking device and FIGS. 9F-9K show the marking device of FIG. 9E located on an object;

FIG. 10A is a regular LED which projects a light corn pattern;

FIG. 10B is a diagram depicting a light corn pattern covering a screen wherein the center of the light corn pattern is located at a first location on the screen; and

FIG. 10C is a diagram depicting a light corn pattern covering a screen wherein the center of the light corn pattern is located at a second location on the screen.

### DETAILED DESCRIPTION OF THE INVENTION

The present invention in one or more embodiments provides a solution that can make shooting video games much more realistic on computers or similar devices, such as the PLAYSTATION (trademarked) or Playstation 2 (trademarked) from SONY (trademarked), or the XBOX (trademarked) from MICROSOFT (trademarked) that contain at least one processor, a memory device and/or a storage device, a monitor or a display screen, such as a television set, a low cost light sensing device, an input computing device and a mock shooting device.

A system, apparatus, and method according to the present invention uses a mock shooting device, such as a mock gun, a mock machine gun, or a mock rocket launcher, with a lighting device and a wireless commanding device. A game player uses the mock shooting device with the lighting device being turned on to aim at one of one or more target objects displayed on a screen by a video shooting game. When the mock shooting device is triggered, the wireless commanding device sends a shooting command signal to the input computing device via a wireless command receiving device. The mock shooting device can be triggered continuously with a predefined time interval when its triggering device is pulled back and not released or the mock shooting device can be triggered just one time with a quick pull back and release. The mock shooting device may also provide audio or visual feedback signals indicating that the device has been triggered. For example, the mock shooting device may play a very short and typical gun shooting sound clip when it is triggered. When it is continuously triggered, the very short and typical gun shooting sound clip will be repeated with a predefined time interval as long as the trigger is pulled back and not released.

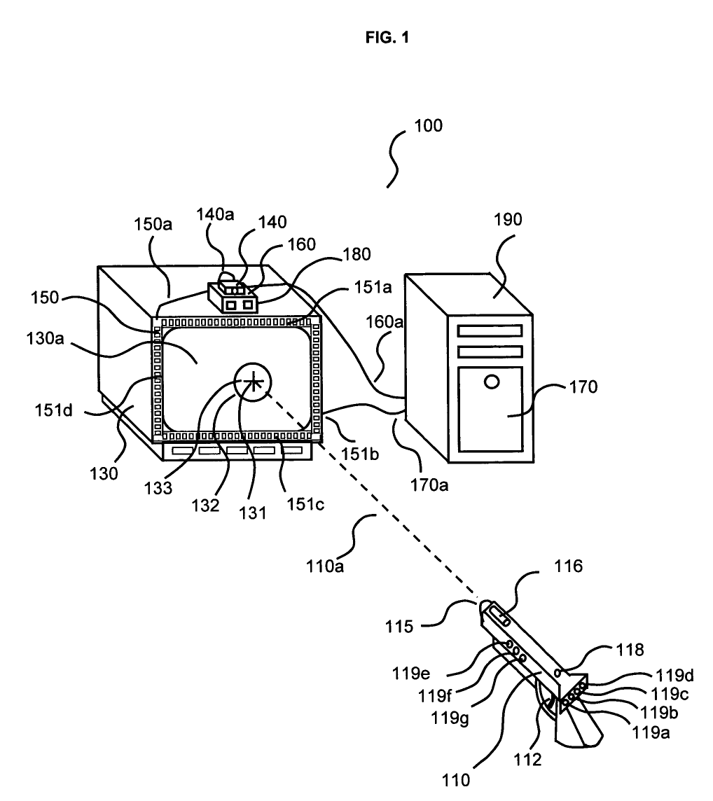

A perspective view of a system, apparatus, and method according to one preferred embodiment of the present invention is shown in FIG. 1. FIG. 1 shows an apparatus 100 comprised of a mock shooting device 110, a screen device 130, a light sensing device 150, an input computing device 160, and a game computing device 170. The input computing device 160 may be a small dedicated computing device. The game computing device 170 may be a personal computer or a game console machine, or other similar device. The screen device 130 is electrically connected to the computing device 170 by communications line 170a. The light sensing device 150 is electrically connected to the input computing device 160 by communications line 150a. The input computing device 160 is electrically connected to the game computing device 170 by communications line 160a. The communications lines 150a, 160a, and 170a may be comprised of wireless connections, hardwired connections, optical connections, software connections, or any other known communication connections. The communications line 160a is in general machine dependent. When Xbox (trademarked) from Microsoft (trademarked) is used for the game computing device 170, 160a typically should be Xbox (trademarked) compatible. In this case, communications line 160a must have a connector identical to the one used by an Xbox (trademarked) game controller. When PS2 (trademarked) by Sony (trademarked) is used for the game computing device 170, communications line 160a should be PS2 (trademarked) compatible. In that case, the communications line 160a typically should have a connector identical to the one used by PS2 (trademarked) game controllers. When a typical PC (personal computer) is for the game computing device 170, communications line 160a may be Universal Serial Bus (USB) or Firewire (trademarked) compatible.

The mocking shooting device 110 includes a lighting device 115. The lighting device 115 may project a large cross pattern in space. The screen device 130 can display target visual objects to be aimed and shot at. The light sensing device 150 may be used to detect light from the lighting device from the mock shooting device 110 and the light sensing device 150 may be mounted onto the screen device 130. The input computing device 160 may be comprised of a hit determination device 180, which may be comprised of computer software which is part of and is running on the input computing device 160. The hit determination device 180 may determine the hit position, such as hit position 131, on the screen device 130 at which the mock shooting device 110 was aiming and shooting.

The shooting path (trajectory) 110a is the virtual shooting path of a virtual bullet from the mock shooting device 110 to the screen device 130. The screen device 130 includes a screen 130a on which visual target objects, such as target object 132, are displayed. The game computing device 170 is responsible for running the shooting game 190, which may be comprised of computer software, that displays visual target objects to be shot at on the screen 130a and reacts accordingly depending on whether a visual target object has been hit or not. With some exceptions, the video shooting game 190 may be similar to those prior art video shooting games which are typically comprised of computer software and which run on computers or game console machines. One of the differences of the present invention is how user shooting information is inputted into the game computing device 170. The system and method according to the present invention uses a realistic mock shooting device 110 with a lighting device 115, a light sensing device 150, and an input computing device 160 for inputting user shooting information while conventional prior art games use a keyboard, mouse, game pad or joysticks.

In addition to a switch 118 for activating the lighting device 115, the mock shooting device 110 is further comprised of a trigger 112 and a plurality of control buttons of an integrated control pad, such as buttons 119a-g. The control buttons 119a-g may be placed anywhere on the mock shooting device 110 as long as the buttons 119a-g can easily be reached and operated by the thumbs or fingers of a game player. The placement of the switch 118 and the control buttons 119a-g shown in FIG. 1 serves only as one example for the simple illustration purpose. They may in principle be placed anywhere on the mock shooting device 110 as long as they are ergonomically placed and easily accessible. More ergonomic designs may be employed to make the switch 118 and the control buttons 119a-g more accessible and more efficient. Furthermore, control buttons 119a-g shown in FIG. 1 are not limited to common type of push buttons. They are comprised of all types of control buttons, switches, and mini-pads, used by PS2 (trademarked), Xbox(trademarked), GameCube(trademarked), and other game control devices used by PCs (personal computers). When one of the control buttons of 119a-g is operated, the commanding device 116 sends a control command to the command receiving device 140 which is connected to the input computing device 160 via the communications line 140a.

In operation, referring to FIG. 1, a game player starts a video shooting game 190 stored in the game computing device 170. The video shooting game 190 may be initially supplied to the game computing device 170 via compact disc, floppy disc, downloaded from the Internet, or in any other known manner. The shooting game 190 displays scenes with one or more visual target objects, such as circular target object 132, on the screen 130a via communications line 170a. Typical examples of the communications line 170a are common video display cable and the Universal Serial Bus (USB) cable version 1.1 and 2.0 for computer monitors, and composite video, S-video, or RGB (red, green, blue) video cables for television sets. The game player uses the mock shooting device 110 to aim and shoot at the displayed target objects provided by the video shooting game 190 on the screen 130a. After the game player starts the game, the light of the lighting device 115 will be turned on using the switch 118. The lighting device 115 is integrated within the front opening (cannot not be seen directly in FIG. 1) of the mock shooting device 110. The light sensing device 150 placed surrounding the screen device 130 detects the light from the lighting device 115, converts the light signals into electronic signals and sends them through communications line 150a to the input computing device 160. Typical and common examples of the communications line 150a are the Universal Serial Bus (USB) cable version 1.1 and 2.0, or cables made according to the IEEE 1394 standard, such as the FIREWIRE (Trademarked) and the ILINK (Trademarked copyrighted), or just a dedicated cable containing wires for sending electronic signals. The hit position determination device 180 running on the input computing device 160 then processes the electronic signals from the light sensing device 150. The hit position determination device 180 computes the hit position of the lighting device 115 based on the intersecting positions (points) of the projected cross pattern of the lighting device 115 with the four strips, 151a-d, of the light sensing device 150 (details will be discussed later). The hit position is then passed from the input computing device 160 to the video shooting game 190 running on game computing device 170 via the communications line 160a. By using the hit position information, a target cursor 133 as shown in FIG. 1 is displayed on the screen 130a so that the game player can see where exactly is his/her shooting device pointing to and determine how it should be moved to hit a target object of interest. When the target cursor 133 is right on top of the target object, such as target object 132, the game player can trigger the mock shooting device 110 to shoot at the target object, such as 132. When the mock shooting device 110 is triggered by operating the trigger 112, the wireless commanding device 116 sends a shooting command to the wireless command receiving device 140. The shooting command is then fed to the input computing device 160 that further sends it to the game computing device 170 running the video shooting game 190. The video shooting game 190 running on the game computing device 170, determines whether an actual visual target object, such a target object 132, has been hit or not by the virtual bullet from mock shooting device 110 and if so the shooting game 190 executes the appropriate computer software instructions for a “hit” scenario. When any one of the control buttons 19a-g of the mock shooting device 110 shown in FIG. 1 is operated, its wireless commanding device 116 sends a command that is associated with the particular control button to the wireless command receiving device 140. The command is then fed via the communications line 140a to the input computing device 160 that further sends it to the game computing device 170 running the video shooting game 190 for causing a desirable action of the game.

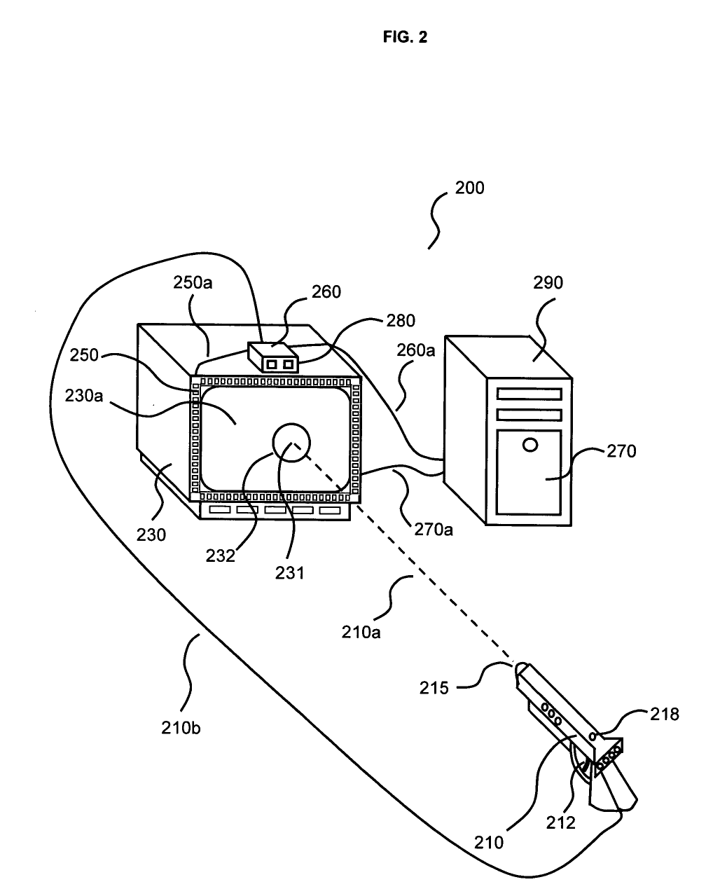

A perspective view of a system, apparatus, and method according to another embodiment of the present invention is shown in FIG. 2. FIG. 2 shows an apparatus 200 comprised of a mock shooting device 210, a screen device 230, a light sensing device 250, an input computing device 260, and a game computing device 270. The input computing device 260 may be a small dedicated computing device. The game computing device 270 may be a personal computer, a game console machine or a similar device. The screen device 230 is electrically connected to the computing device 270 by communications line 270a. The input computing device 260 is electrically connected to the game computing device 270 by a communications line 260a. The light sensing device 250 is electrically connected to the input computing device 260 by communications line 250a. The communications lines 250a, 260a and 270a may be comprised of wireless connections, hardwired connections, optical connections, software connections, or any other known communication connections. Devices 210, 230, 250, 260 and 270 of apparatus 200 shown in FIG. 2 are similar to the devices 110, 130, 150, 160 and 170 of apparatus 100 shown in FIG. 1. In comparison with the apparatus 100 shown in FIG. 1, the apparatus 200 has the following main differences. The wireless connection has now replaced by a wired communications line 210b. For that reason the wireless commanding device 116 and the wireless command receiving device 140 are not needed in the FIG. 2 embodiment. All control command signals from the mock shooting device 210 are now sent to the input computing device 260 in the embodiment of FIG. 2, and received via the communications line 210b. The main advantage of this approach is its low cost and simple implementation. The main drawback is the constraint of movement freedom of a game player caused by such a wired cable, such as 210b between the mock shooting device 210 and the computing device 270.

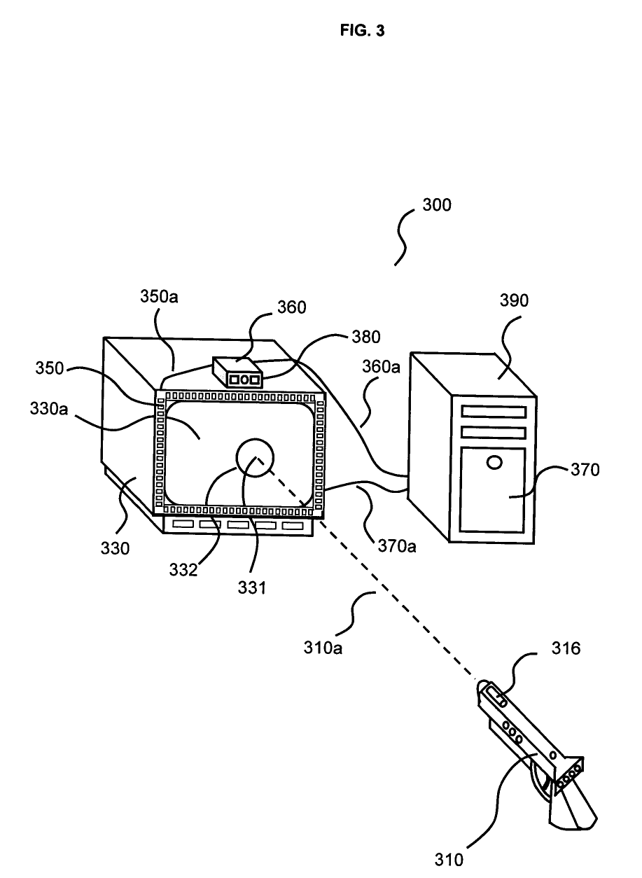

The apparatus 100 shown in FIG. 1 may be simplified by integrating the wireless command receiving device 140 into the input computing device 160. As shown in FIG. 3, the apparatus 300 has one less component and one less connection line in comparison with apparatus 100. This can make the whole system cheaper and compacter with less messy cables. Devices 310, 316, 330, 350, 380, 370, and 390 of apparatus 300 shown in FIG. 3 are similar to the devices 110, 116, 130, 150, 180, 170 and 190 of apparatus 100 shown in FIG. 1. Also components 310a, 330a, 331, 332, 360a, and 370a are the same as similarly numbered components 110a, 130a, 131, 132, 160a, and 170a. However, the input computing device 360 of apparatus 300 now contains an integrated wireless command receiving device which may be similar to device 140 shown in FIG. 1.

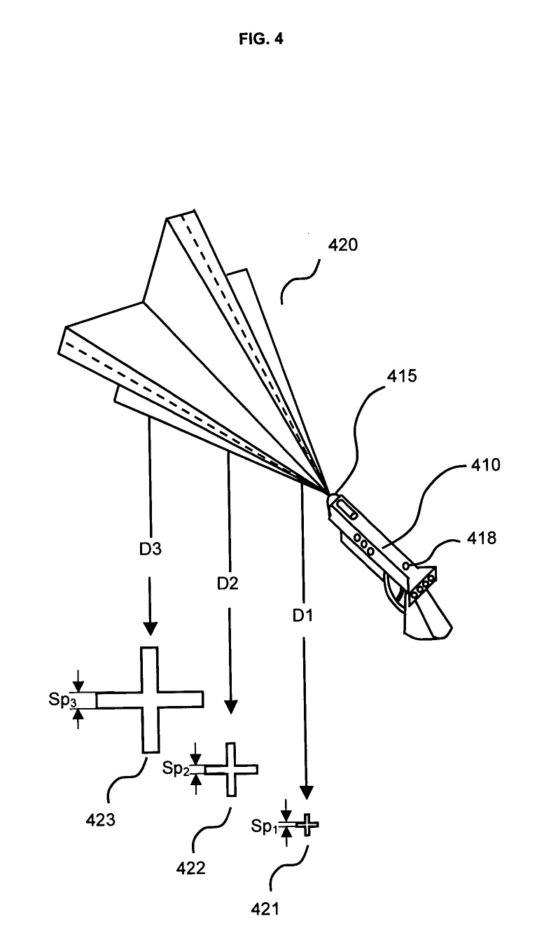

FIG. 4 is a perspective view schematically illustrating a cross light pattern generated by a lighting device 415 of a mock shooting device 410. When the lighting device 415 of mock shooting device 410 has been turned on by switch 418, it projects a cross pattern 420 in space as illustrated in FIG. 4. Devices 410, 415 and 418 may be the same as or similar to devices 110, 115 and 118, shown in FIG. 1 or devices 210, 215, and 218 shown in FIG. 2, or devices 310, 315, and 318 shown in FIG. 3. The cross pattern 420 can be visible or invisible to human eyes, but must be well “visible” (detectable) by a light sensing device, such as light sensing device 150 of FIG. 1, light sensing device 250 of FIG. 2, or light sensing device 350 of FIG. 3. The cross pattern 420 should have the following spatial characteristics. The cross pattern 420 should get larger as the distance increases between the lighting device 415 and a projected plane. This spatial property can be illustrated by a projection plane which is roughly perpendicular to the direction at which the mock shooting device 410 (hence the lighting device 415) is aiming, i.e. projection plane should be perpendicular to the direction of the trajectory line, such as trajectory lines 110a, 210a, and 310a. If the projection plane is first placed at distance D1, then secondly placed at distance D2, and then thirdly placed at distance D3, three cross patterns 421, 422, and 423, respectively with increased sizes can be obtained, as shown in FIG. 4. In addition to the increased size, the spread of the cross pattern, as shown in FIG. 4 is also getting larger with the distance between the projection plane and the lighting device 415. The spread for the distances D1, D2, and D3, is shown as Sp₁, Sp₂, and Sp₃, respectively, in FIG. 4.

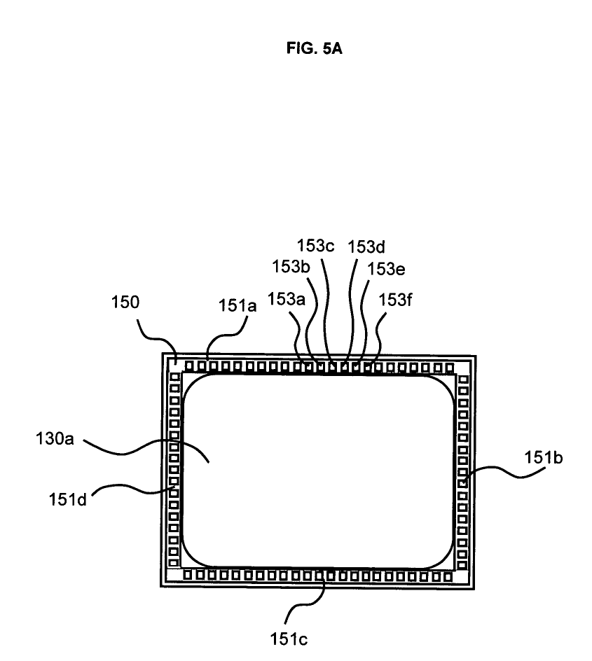

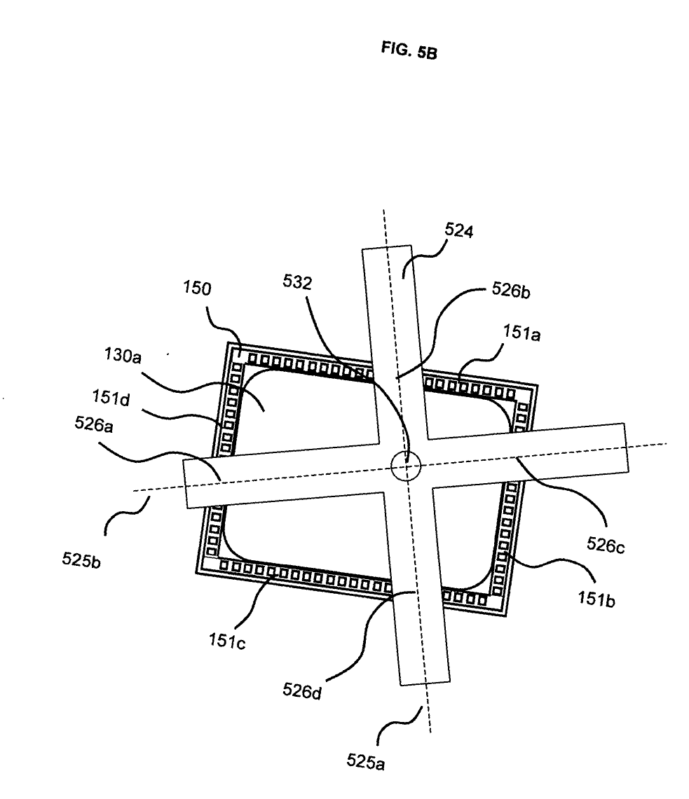

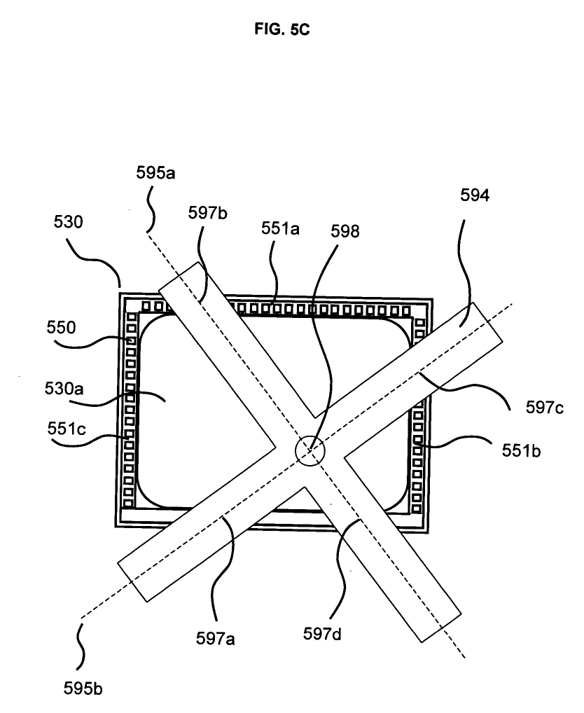

FIG. 5A shows a more detailed view of the light sensing device 150 with four light sensing strips 151a, 151b, 151c, and 151d that may easily be attached to surround the screen 130a as shown FIG. 1. Each of the light sensing strips 151a-d is comprised of a plurality of photo sensitive diodes or transistors, or any other type of detectors that can convert light (photon) signals into electronic signals (also known as light detectors or light sensors. Both names will be used interchangeably throughout the present invention) such as 153a and 153b. There is typically a small and equal distance between them the light detectors such as the distance between 153a and 153b. This distance may vary depending on the resolution of the hit position of the apparatus, such as apparatus 100. In general, the smaller the distance, the more light detectors are needed for the same length of the strip, such as strip 151a, and the higher the resolution of the hit position. The length of each of the light sensing strips of strips 151a-d is depending on the actual screen size, of screen 130a to be surrounded. The four light sensing strips 151a-d are connected. Therefore, all electronic signals from them are collected and passed to the input computing device 160 via, for example, the communications line 160a as shown in FIG. 1.

When the cross pattern of the lighting device 150 shown in FIG. 1, such as similar to the cross patterns 420, 421, 422, and 423 shown in FIG. 4, is projected on to the light sensing device 150 with four strips 151a-d, center lines 525a and 525b of a cross pattern 524 may in general have four intersecting positions with the four strips 151a-d as shown in FIG. 5B as long as the size of the cross pattern 524 is large enough to cover the screen 130a plus at least part of each of the strips 151a-d. The four intersection points or positions are 526a, 526b, 526c, and 526d. The positions 526a, 526b, 526c, and 526d are intersection points of the cross pattern 524 with the strips 151d, 151a, 151b, and 151c, respectively. The four intersecting positions 526a-d reveal the actual position of the center of the cross pattern projected on to the screen device 130 by the lighting device, such as device 115, of the mock shooting device, such as 110. If we assume that the center 532 of the cross pattern 524 is the hit position at which the mock shooting device 110 is aiming, then the hit position 532 can easily be detected by detecting the center 532 of the cross pattern 524 projected onto the screen device 130.

Please note that we don't always need four strips 151a-151d (hence four intersecting positions) to determine the center of the cross pattern, such as 524, projected on to the screen device 130. Mathematically, it can easily be shown that in general only three intersecting positions are needed to determine the center position, such as 532 of the cross pattern 524, if we assume that the two crossing lines, such as 525b and 525a, of the cross pattern, such as 524, are perpendicular to each other. In general, two points (positions) determine one line. The third point (position) with the perpendicular condition to the first line determines the second line. When both lines are determined, their intersecting point (in this case the center position of the cross pattern) can easily be computed. Therefore, it may be possible to use three sensor strips (i.e. can eliminate one of strips 151a-d) instead of four. For example, FIG. 5C shows a screen device 530 on which is located a light sensing device 550 which includes strips 551a, 551b, and 551c. Strips 551a-551c, may be similar to strips 151a, 151b, and 151d shown in FIG. 5A. FIG. 5C shows a cross pattern 594 which includes crossing lines 595a and 595b.

The three strip embodiment of FIG. 5C may not work well if the mock shooting device, such as 110, has a large rotation angle as shown in FIG. 5C. A large rotation angle means that crossing line 595b is at an angle, which is substantially greater than zero with respect to horizontal strip 551a. In this case, because the bottom sensor strip is omitted, only two intersecting positions 597b and 597c can be detected. The positions 597a and 597d which would normally be intersecting points cannot be detected due to the absence of a bottom sensor strip, such as strip 151c shown in FIG. 5A. Since three intersecting positions are needed for determining the two lines of a cross pattern, the two determined positions 597b and 597c are not sufficient to determine the center position 598 of the cross pattern 594. Only if the rotation angle is small, say less than 15 degrees (the actual angle depends on the height and the width of the screen), three intersecting positions may be available with three sensor strips, such as strips 551a, 551b, and 551c and the center position 598 of the cross pattern 594 can in this case still be computed. Since we cannot always control the rotation angle of the mock shooting device, it is more robust to use four sensor strips instead of three.

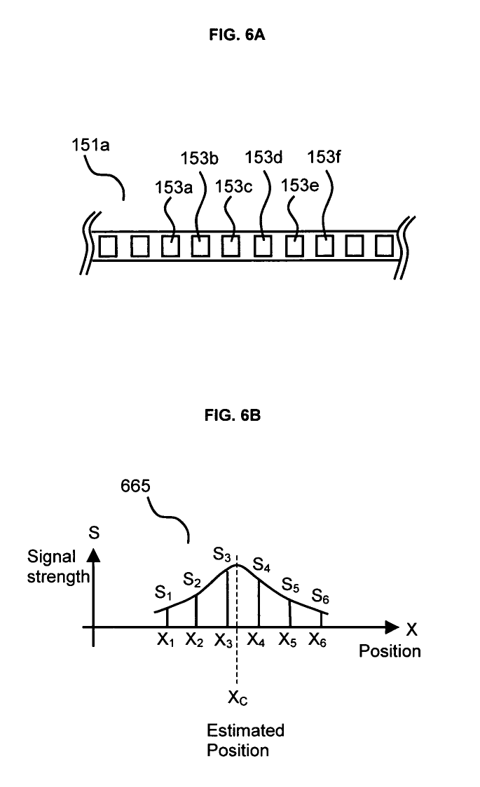

The accuracy of the hit position determination depends on the accuracy of the position determination of the four intersections (in the FIG. 5B example, intersection positions 526a-d) between the light cross pattern, such as 524, and the four sensor strips, such as 151a-d. As shown in FIG. 6A, a small section of sensor strip 151a is shown with several light detectors, such as light detector 153a shown. When light is projected on this section of the sensor strip 151a, the photo sensors, such as 153a, detect the light and convert the light energy into electronic signals. The signal strength is proportional to the light energy received by the photo sensors, such as 153a-153f in FIG. 6A. For computing the position of an intersection, such as for example intersection 526b of FIG. 5B, a weighted average of the signal strength may be a simple and fast solution. The estimated position Xc can be computed as follows, assuming only six sensors, sensors 153a-153f, in this example actually detect signal, (i.e. are in a sense actually covered by the crossing line 526b of the pattern 524), over a certain signal strength as shown in FIG. 6:

$$Xc = \frac{X1 * S1 + X2 * S2 + X3 * S3 + X4 * S4 + X5 * S5 + X6 * S6}{S1 + S2 + S3 + S4 + S5 + S6}$$

In the above example, X1-X6, are the positions of sensors 153a-f, and S1-S6 are the signal strengths coming from the sensors 153a-f. Since one sensor strip, such as 151a, may have two intersecting positions with the cross pattern, the position estimation should always be performed within a certain neighborhood. I.e. the above calculation was performed with only six adjacent sensors, 153a-f, on the strip 151a. In general, if N sensors detecting signal over certain signal strength in a neighborhood, the estimated position Xc can be computed as follows:

$$Xc = \frac{{\sum }_{i = 1}^{N} Xi * Si}{{\sum }_{i = 1}^{N} Si}$$

There are more sophisticated and accurate methods for computing the estimated position if the exact mathematical description of the signal curve 665, shown in FIG. 6B, is known. For example, if the curve, such as curve 665 can be described well by a Gaussian function, a Gaussian curve fitting method for estimating the position may be useful. Other curve fitting or robust estimation methods may also be used to get more accurate position estimation. Since these other methods are standard methods for curve fitting or position estimation and they are not essential to the current invention, the details will be skipped for clarity. After the position estimation of all four intersections, such as for example, intersections 526a-d in FIG. 5B, the projected cross center, such as 532, on the screen device 130 or screen 130a can easily be obtained.

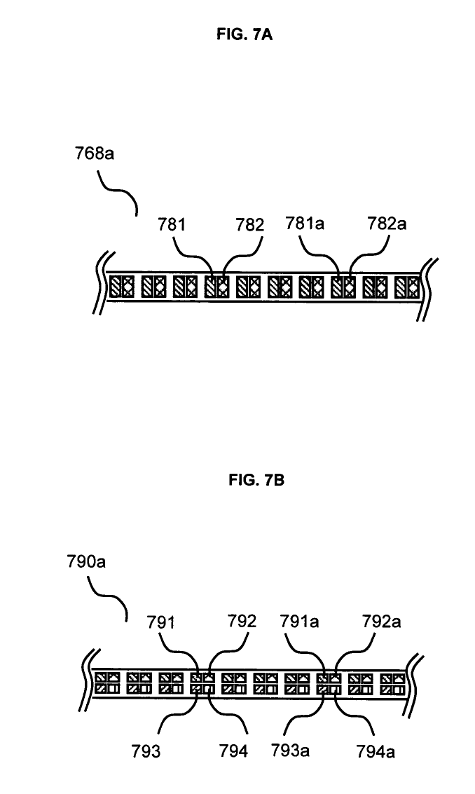

The apparatus 100, 200, and 300 shown in FIGS. 1-3, respectively, may be extended to include a plurality of mock shooting devices, each of which may be identical to the mock shooting device 110 equipped with lighting device 115 using different light characteristics for multiple game players. One of the useful light characteristics is its wavelength. Different light wavelengths in the visible light range correspond to different light colors. Since both visible and invisible light sources may be used in the present invention and no color concept is defined in the invisible range, we will use the more general term “wavelength” instead of “color” throughout the present application. The light sensing devices 150, 250 and 350 shown in FIGS. 1-3 can be extended to contain a plurality of sets of light sensors sensitive to different light wavelengths. The plurality of sets of light sensors may be placed interleaved so that each set of light sensors may surround the screen, such as screen 130, evenly. For example, for a dual user apparatus, two mock shooting devices, each like 110, 210, or 310, one mock shooting device having a lighting device emitting light with one light wavelength w₁, and one mock shooting device having a lighting device emitting light with another light wavelength w₂, where w₁ and w₂ are different, may be operated by two game players. The aiming location of the two mock shooting devices on the screen, such as 130a, may be determined by the light sensing device, placed similarly around the screen device 130 such as device 150, 250 and 350 shown in FIGS. 1-3, respectively. However, the light sensing device for dual users may be comprised of two sets of light sensors. A section of a light sensing strip 768a, which may for example be used in place of strip 151a for dual users is shown in FIG. 7A. The section of the strip 768a for dual users is comprised of a first set 781 of sensors, including sensor 781a, and a second set 782 of sensors, including sensor 782a. While the first set of sensors 781 is designed to only detect light from a first lighting device of a first mock shooting device with a first light wavelength of w₁, the second set of sensors 782 is designed to only detect light from a second lighting device of a second mock shooting device with a second light wavelength of w₂. The two wavelengths, w₁ and w₂ are typically significantly different, in this example. The signal response of the first set of sensors 781 to light from the second lighting device of the second mock shooting device with wavelength w₂ is so low that it can effectively be ignored. Similarly, the response of the second set of sensors 782 to light with wavelength w₁ is so low that it can be ignored. Similarly, light sensing devices, such as a set of sensors for each user for three, four, and more users may be built similarly. A section of a strip 790a of light sensors for four users is depicted in FIG. 7B. The section of the strip 790a is comprised of a first set of sensors 791 including sensor 791a, a second set of sensors 792, including sensor 792a, a third set of sensors 793, including sensor 793a, and a fourth set of sensors 794, including sensor 794a. Each set of sensors of sets 791-794, is designed to detect light from the only one lighting device emitting light with a matching wavelength. When the wavelength differences among the four sets of sensors 791-794 are significantly large, each of the four sets 791-794 can work independently and detect four intersecting positions for determining the center position of a cross pattern projected by each of four mock shooting devices. This example illustrates how multiple players can play a video game with multiple mock shooting devices. However, when the light sensing device is capable of detecting lights from multiple lighting devices, it is not only useful in the situation where multiple players are present. It can easily be seen that such a light sensing device is also very useful to some video games where multiple positions of objects are needed to revealed, such as a video boxing game where the positions of both fists of a boxer need to be inputted or controlled.

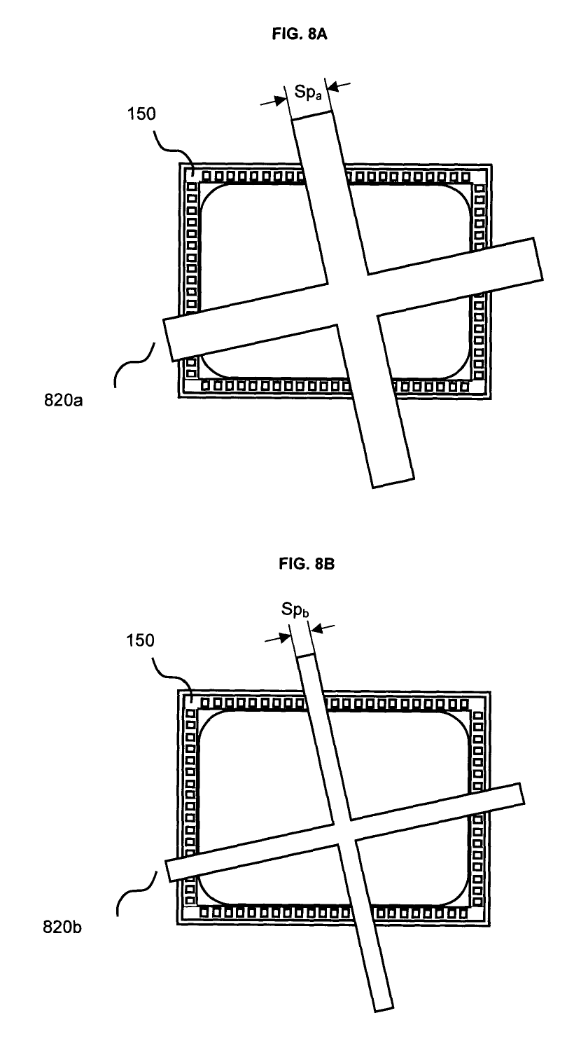

In fact, not only the cross center location, such as 532 in FIG. 5B, projected on to the screen 130a, can be determined accurately, but also the distance between the screen 130a and the lighting device, such as device 115, can be estimated. As shown in FIG. 8A, a cross pattern 820a projected by a lighting device, such as 115, on the light sensing device 150 at a distance dₐ has a pattern spread Spa. The cross pattern 820b projected by the lighting device, such as 115, at another distance d_{b} on the light sensing device 150 has a pattern spread Sp_{b}, which is different than the pattern spread Spₐ shown in FIG. 8A. Since the pattern spread of a cross pattern increases with the distance between the lighting device, such as 115, and the light sensing device, such as 150, as mentioned previously, it can easily be concluded that dₐ is greater than d_{b}. When it is assumed that the relationship between the distance and the pattern spread is linear, the distance can easily be estimated from the pattern spread after simple calibration. Because both cross pattern center location, such as 532 in FIG. 5B, as well as the distance between the light sensing device, such as 150 (hence the screen 130a) and the lighting device, such as 115 of the mock shooting device may be determined. Because the distance may be determined, the lighting device, such as 115, used in the mock shooting device (where no distance information between the mock shooting device and the screen is needed), such as 110, may also be used for other applications where distance information is required.

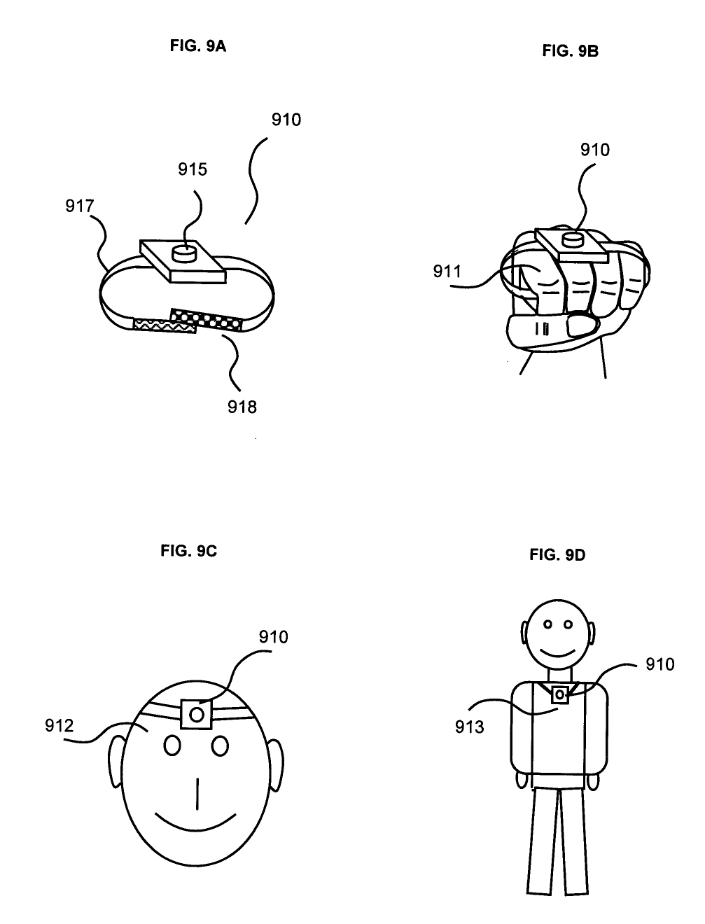

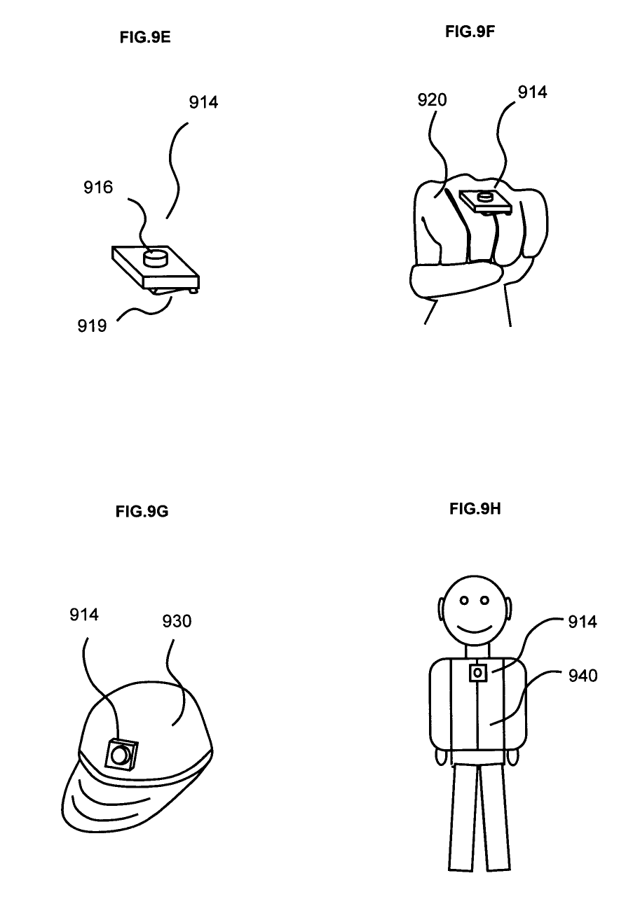

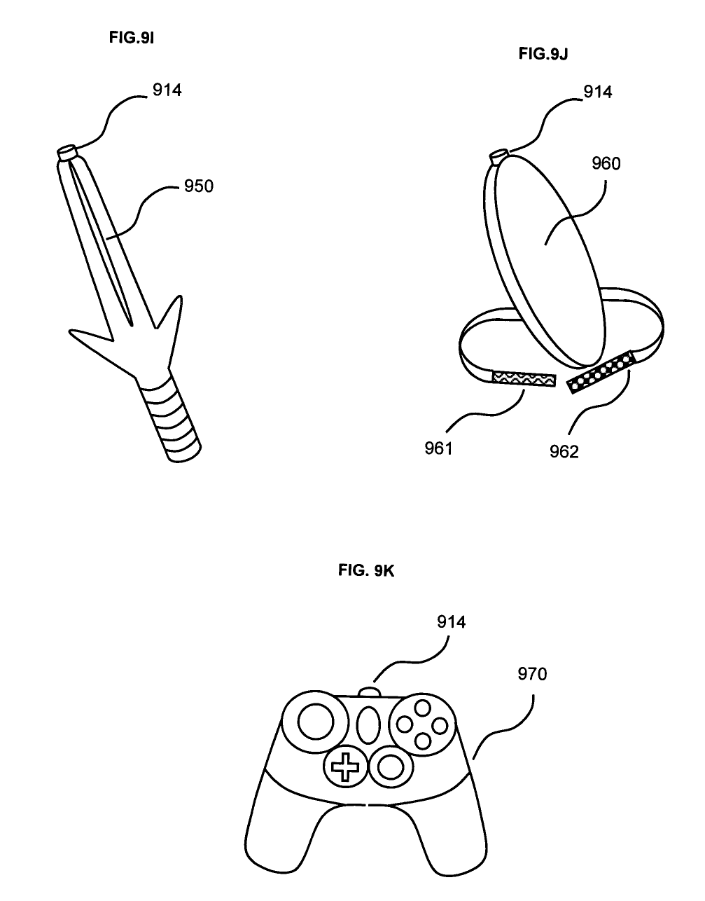

If the lighting device 115 is taken out of the mock shooting device 110 and an attachment device is added to the lighting device 115, a standalone marking device (which can be called a marking device because it can mark the position of an object in space when the marking device is attached to the object) for many applications may look like the device 910 as shown in FIG. 9A. As depicted in FIG. 9A, the marking device 910 is comprised of a lighting device 915, a flexible member 917, and an attachment member 918 which may be VELCRO (trademarked) based. The marking device 910 can be used in many different ways for a wide range of applications. Several application examples are shown in FIGS. 9B, 9C, and 9D. If, as in FIG. 9B, the marking device 910 is attached to a fist, such as fist 911 of a boxing game player, the position of the fist in space may be determined. If, as in FIG. 9C, the marking device 910 is attached to the forehead 912 of a video game player, the head movement of the player may be determined. If body movement needs to be determined, marking device 910 may be attached to a body part, such as a chest 913 in FIG. 9D. When only one such device, such as device 910 is used for playing a video game, the light sensing device, such as 150, of FIG. 1, needs only one set of light sensors. When more than one device, like or identical to device 910 are used to play a video game, the light sensing device, needs to contain the same number of sets of light sensors for detecting the position of the individual marking device. For example, for playing an interactive boxing video game, a game player may want to input positions of the two fists, the head, and the chest. In this case, four marking devices, each similar to or identical to device 910, may be used simultaneously and therefore four sets of light sensors, such as similar to the sets 791-794 in FIG. 7B, would typically be needed in the light sensing device. If two players are permitted to play the same boxing game against each other, assuming four marking devices, each similar to device 910 for each player, eight marking devices, similar to 910 and hence eight sets of light sensors for the light sensing device may be needed.

A standalone marking device, may also use other attachment possibilities to make the device even more flexible to use. FIG. 9E, shows a marking device 914 comprised of a lighting device 916 and an attachment member 919. The attachment member 919 could in general be anything that can attach to other objects and/or surfaces, such a clip, a clamp, a VELCRO (trademarked) surface that can attach to other VELCRO (trademarked) or textile surfaces, and other simple binding means. Because the attachment member 919 is typically on the backside of the lighting device 916 in FIG. 9E, the whole marking device 914 is very compact. Therefore, it can easily be attached to many different objects. Several examples are also shown in FIGS. 9F-9J. The marking device 914 may be attached to a hand glove 920 as an input device for playing boxing games as shown in FIG. 9F. The marking device 914 may be attached to a hat 930 that can be used by a game player wearing the hat for inputting his head movement as shown in FIG. 9G The head movement can for example be used to control the viewing angle or the moving direction of a character in a video game who can actively seek and destroy targets. Similarly, the marking device 914 may be used to attach to a shirt 940 of a game player for inputting the body movement of the game player as shown in FIG. 9H. The marking device 914 may also be directly embedded into a mock sword 950, as shown in FIG. 91, in such a way that a game player may use the mock sword 950, to control the movement of a fighting character in video games using a sword or similar weapons. Another good application example is to embed the marking device 914 into a mock snow-boarding device 960 as shown in FIG. 9J. The mock snow-boarding device 960 having two flexible members with VELCRO (trademarked) belts 961 and 962 can easily be attached to a hand of a snow-boarding game player. The player can for example move his/her hand with the attached mock snow-boarding device 960 to control the movement of a snow-board of a character in a snow-boarding video game. Another good example of using such a marking device is to embed it into a game control pad for Xbox (trademarked) or PS2 (trademarked). As shown in FIG. 9K, a marking device 914 is integrated into a typical game control pad 970. Now, a game player can use this new device 970 to play a wide range of games where revealing the position of the device 970 is needed.

As shown by FIGS. 9A-9K, marking devices can be attached to or embedded into a wide range of input control devices or objects. In the present application, any input control device or object with a marking device is called a mock control device. For example, a hand glove with a marking device is a mock control device because it can be used to reveal the position of a hand/fist wearing it. A hat with a marking device can also be seen as a control device since it can be used to input the position of a head wearing it. A sword or a snowboard with a marking device also qualifies as a mock control device because they can be used to control a movement of a sword or a snowboard in a video game. More examples of mock control devices can easily be found, such as a mock tennis racket, a mock table tennis paddle, etc. In general, a mock control device can be used in many different ways with a wide range of interactive video games.

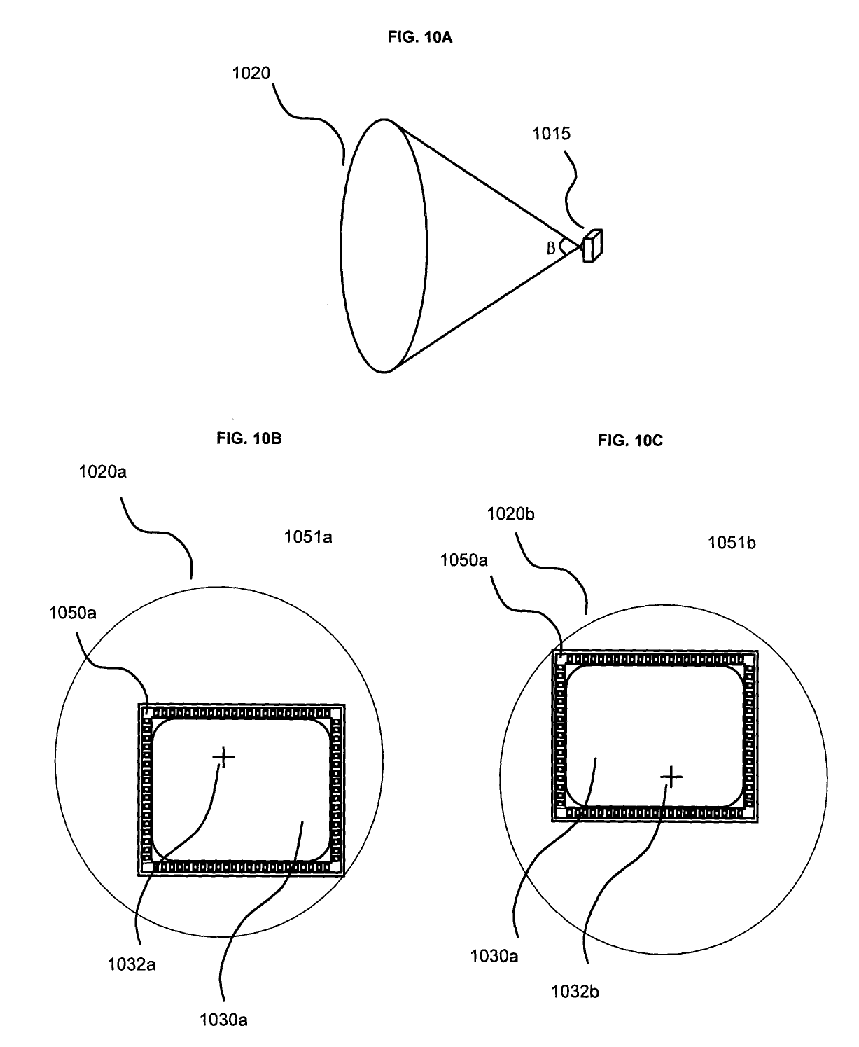

Although we have only discussed one particular light pattern, a cross light pattern, for position determination of a lighting device or marking device by a light sensing device. It can easily be seen that other light patterns may also be used for this purpose. For example, a regular LED with a large viewing angle β, such as 60 degrees, as depicted in FIG. 10A, may directly be used in a lighting or in a marking device. In this case, as shown in FIG. 1A, a marking device 1015 will project a light corn pattern 1020 in space. When the diameter of the light corn pattern is large enough to cover a screen 1030a and light sensing device 1050a as shown in either FIG. 10B or FIG. 10C, the center of the corn pattern, such as 1032a in FIG. 10B or 1032b in FIG. 1C, may be seen as the aiming position of a marking device on the screen 1030a. FIGS. 10B and 10C depict two different positions, 1032a and 1032b projected by a marking device onto the screen 1030a. When the corn light pattern is modeled with M unknowns, and only M+6 light sensors are needed in the light sensing device, such as 1050a to determine the M unknowns from the light pattern and six additional position (three translation and three rotation parameters) unknowns of the light pattern, such as 1020, in space. A set of M+6 equations can easily be solved and the position of the pattern, such as 1020 can easily be determined. If a corn light pattern can be modeled with for example 10 unknowns, then only 16 light sensors may be needed. Even if several more light detectors are added for creating some redundancy in the system, the total number of the light sensors may still be small in comparison with the number of light sensors needed for working with a cross light pattern. Therefore, it is possible to use less light sensors in the light sensing device when the corn light pattern is used. However, the computation in this case may be more complex and the accuracy of the determined position may not be as high as the one from a cross light pattern with more densely packed light sensors. Therefore, for some video games, such as a dancing pad video game, where no high position accuracy is required, the corn light pattern with less light sensors may be useful. The main advantage is a corn light pattern based system is the fact that much less number of sensors may be needed for the light sensing device, hence lower production cost. In addition to cross and corn light patterns, there are some other useful light patterns, such as a ring light pattern or a double cross light pattern. In general, some other light patterns of a light device with some other arrangements of the light sensors of a light sensing device may be useful for some particular video games. Such changes and modifications may reasonably be included within the scope of the present invention.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising
a game computing device;
an input computing device;
a screen device having a screen;
a light sensing device; and
a first mock shooting device having a first lighting device;
wherein the light sensing device detects light from the first lighting device; and
wherein the input computing device uses signals from the light sensing device to determine whether the first mock shooting device is aimed towards a first location on the screen of the screen device; and
wherein the input computing device sends the determination of whether the first mock shooting device is aimed towards the first location to the game computing device.

2. The apparatus of claim 1 wherein
wherein the light sensing device surrounds the screen.

3. The apparatus of claim 1 wherein
wherein the light sensing device is comprised of a plurality of light sensors.

4. The apparatus of claim 1 wherein
the light sensing device is comprised of four sensor strips placed around the screen; and
wherein each of the four sensor strips is comprised of a plurality of light sensors;

5. The apparatus of claim 1 wherein
the first lighting device of the first mock shooting device projects a light pattern onto the light sensing device; and
wherein the light sensing device is electrically connected to the input computing device and provides data about the first lighting device to the input computing device.

6. The apparatus of claim 1 wherein
the first lighting device of the first mock shooting device projects a cross light pattern onto the light sensing device; and
wherein the light sensing device is electrically connected to the input computing device and provides data about the first lighting device to the input computing device.

7. The apparatus of claim 1 wherein
wherein the first mock shooting device is further comprised of a wireless commanding device; and
wherein the wireless commanding device sends a shooting command when the first mock shooting device is triggered.

8. The apparatus of claim 7 wherein the first mock shooting device is further comprised of one or more control buttons;
and wherein the control buttons may be used to send control command signals; and
the wireless commanding device sends a unique command signal when one of the control buttons on the first mock shooting device is operated.

9. The apparatus of claim 1 further comprising
a wireless command receiving device; and
wherein the wireless command receiving device is electrically connected to the input computing device and passes command signals received from the wireless commanding device to the input computing device.

10. The apparatus of claim 1 wherein
the input computing device includes an integrated wireless command receiving device that computes the aiming position of the first lighting device on the screen and receives command signals from the wireless commanding device of the first mock shooting device.

11. The apparatus of claim 1 wherein
the first mock shooting device is further comprised of a wired communications line;
and wherein the wired communications line communicates command signals directly from the first mock shooting device to the input computing device.

12. The apparatus of claim 1 wherein
light from the first lighting device is visible to human eyes and to the light sensing device.

13. The apparatus of claim 1 wherein
light from the first lighting device is invisible to human eyes but visible to the light sensing device.

14. The apparatus of claim 1 further comprising
a second mock shooting device comprised of a second lighting device;
wherein the first lighting device of the first mock shooting device has a first characteristic;
wherein the second lighting device of the second mock shooting device has a second characteristic; and
wherein the first characteristic and the second characteristic are different.

15. The apparatus of claim 14 wherein
the first characteristic is comprised of a first light wavelength which is emitted from the first lighting device of the first mock shooting device;
the second characteristic is comprised of a second light wavelength which is emitted from the second lighting device of the second mock shooting device; and
wherein the first wavelength is different from the second wavelength.

16. The apparatus of claim 14 wherein
the first characteristic is comprised of a first light pattern which is emitted from the first lighting device of the first mock shooting device;
the second characteristic is comprised of a second light pattern which is emitted from the second lighting device of the second mock shooting device; and
wherein the first pattern is different from the second pattern.

17. The apparatus of claim 1 wherein
the first mock shooting device is comprised of a first identifier;
and further comprising a second mock shooting device comprised of a second identifier;
wherein the first identifier and the second identifier are different; and
wherein the first mock shooting device uses the first identifier to send command signals with a first characteristic;
wherein the second mock shooting device uses the second identifier to send command signals with a second characteristic; and
wherein the first characteristic and the second characteristic are different.

18. The apparatus of claim 1 wherein
the light sensing device is comprised of a plurality of sets of light sensors; and
wherein each set of light sensors detects light with a certain characteristic.

19. The apparatus of claim 18 wherein
the plurality of sets of light sensors are placed interlaced around the screen.

20. A method comprising the steps of
using a light pattern from a first lighting device fixed to a first mock shooting device to determine whether the first mock shooting device is aimed towards a first location on a screen.

21. The method of claim 20 further wherein
the light pattern from the first lighting device is a cross light pattern.

22. The method of claim 20 further comprising
detecting light from the first lighting device through the use of a light sensing device.

23. The method of claim 20 further comprising
using a wireless commanding device to send command signals from the first mock shooting device.

24. The method of claim 20 further comprising
using a wired communications line to send command signals from the first mock shooting device.

25. The method of claim 20 further comprising
using light from a second lighting device fixed to a second mock shooting device to determine whether the second mock shooting device is aimed towards a second location on a screen; and
wherein the first lighting device emits light with a first characteristic and the second lighting device emit light with a second characteristic and wherein the first characteristic and the second characteristic are different.

26. The method of claim 20 further comprising
using a first identifier for the first mock shooting device; and
using a second identifier for the second mock shooting device; and
wherein the first identifier and the second identifier are different; and
wherein the first identifier enables the first mock shooting device to send commands with a first characteristic and the second identifier enables the second mock shooting device to send command signals with a second characteristic; and
wherein the first characteristic and the second characteristic are different.

27. An apparatus comprising
a game computing device;
an input computing device;
a screen device having a screen;
a light sensing device;
a first mock control device having a first marking device; and
wherein the light sensing device detects light from the first marking device; and
wherein the input computing device uses signals from the light sensing device to determine the position of the first mock control device versus the screen; and
wherein the input computing device sends the determination of the position of the first mock control device with respect to the screen to the game computing device.

28. The apparatus of claim 27 wherein
wherein the first mock control device is a mock boxing glove for inputting fist movement of a game player wearing it.

29. The apparatus of claim 27 wherein
wherein the first mock control device is a mock snow-boarding device.

30. The apparatus of claim 27 wherein
wherein the first mock control device is a mock hat for inputting head movement of a game player wearing it.

31. The apparatus of claim 27 wherein
wherein the first mock control device is a mock sword for inputting sword movement of a game player using it in video fighting games with sword or similar weapons.

32. The apparatus of claim 27 wherein
wherein the first mock control device is a mock game control pad with an embedded marking device for inputting the movement of the mock game control pad.

33. The apparatus of claim 27 wherein
wherein the light sensing device surrounds the screen.

34. The apparatus of claim 27 wherein
wherein the light sensing device is comprised of a plurality of light sensors.

35. The apparatus of claim 27 wherein
the light sensing device is comprised of a plurality of sensor strips placed around the screen; and
wherein each sensor strip is comprised of a plurality of light sensors;

36. The apparatus of claim 27 wherein
the first marking device projects a light pattern onto the light sensing device; and
wherein the light sensing device is electrically connected to the input computing device and provides data about the first marking device to the input computing device.

37. The apparatus of claim 27 wherein
the first marking device projects a cross light pattern onto the light sensing device; and
wherein the light sensing device is electrically connected to the input computing device and provides data about the first marking device to the input computing device.

38. The apparatus of claim 27 wherein
the light sensing device is comprised of a plurality of sets of light sensors; and
wherein each set of light sensors detects light with a certain characteristic.
a second mock shooting device comprised of a second marking device;
wherein the first marking device of the first mock control device has a first characteristic;
wherein the second marking device of the second mock control device has a second characteristic; and
wherein the first characteristic and the second characteristic are different.

39. A method comprising the steps of
using a light pattern from a first marking device fixed to a first mock control device to determine the position of the first mock control device.

40. The method of claim 39 further wherein
the light pattern from the first marking device is a cross light pattern.

41. The method of claim 39 further wherein
the light pattern from the first marking device is a corn light pattern.

42. The method of claim 39 further comprising
detecting the light from the first marking device through the use of a light sensing device.

43. The method of claim 39 further comprising
using a wireless commanding device to send command signals from the first mock control device.

44. The method of claim 39 further comprising
using light from a second marking device fixed to a second mock control device to determine the position of the second mock control device; and
wherein the first marking device fixed to the first mock control device emits light with a first characteristic and the second marking device fixed to the second mock control device emits light with a second characteristic and wherein the first characteristic and the second characteristic are different.
